(19) United States
(12) Patent Application Publication
(10) Pub. No.: US 2026/0332620 A1
(43) Pub. Date: Oct. 22, 2026

(54) SYSTEMS AND METHODS FOR SECURING DATA BY DETECTING AND PREVENTING REAL-TIME DATA LEAKAGES IN CLOUD ENVIRONMENTS

(71) Applicant: BANK OF AMERICA CORPORATION, Charlotte, NC (US)

(72) Inventors: Anny Jaiswal, Kolkata (IN); Hritwik Bhaumik, Kolkata (IN)

(73) Assignee: BANK OF AMERICA CORPORATION, Charlotte, NC (US)

(21) Appl. No.: 19/185,674

(22) Filed: Apr. 22, 2025

(51) Int. Cl. H04L 9/40; H04L 9/08

(52) U.S. Cl. CPC H04L 63/1425; H04L 9/0819; H04L 9/0852

(57) ABSTRACT

Systems, computer program products, and methods are described herein for securing data by detecting and preventing real-time data leakages in cloud environments. The present disclosure is configured to identify at least one data source; collect, by at least one virtual component, data from the data source(s), wherein the data comprises current user data; monitor, by the at least one virtual component, the data from the data source(s); generate, in an instance after the monitoring of the data, encrypted data by applying an encryption layer to the data; apply the encrypted data to an anomaly detection layer; determine, by the ML model, an anomaly indicator based on whether an anomaly is present in the data based on the current user data; determine, by the AI engine, a prediction for the data; and log, in a distributed ledger, the current user data and the anomaly indicator.

### TECHNOLOGICAL FIELD

Example embodiments of the present disclosure relate to securing data by detecting and preventing real-time data leakages in cloud environments.

### BACKGROUND

In today’s environment of using cloud computing and networked computing components, data transmissions have become more prevalent and integral to communications. Thus, enabling scalable, efficient, and secure data transmissions while preventing data leakages in real time and pro-actively has become more and more important. Such data leakages are a critical security concern which has only increased in frequency and importance as personal and identifying data is more widespread. Thus, a great need exists for a system that can efficiently, securely, and dynamically secure data by detecting and preventing real-time data leakages.

Applicant has identified a number of deficiencies and problems associated with securing data by detecting and preventing real-time data leakages. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for securing data by detecting and preventing real-time data leakages in cloud environments.

In one aspect, a system for securing data by detecting and preventing real-time data leakages in cloud environments is provided. In some embodiments, the system may comprise: a memory device with computer-readable program code stored thereon; at least one processing device operatively coupled to the memory device and at least one communication device, wherein executing the computer-readable code is configured to cause the at least one processing device to: identify at least one data source; collect, by at least one virtual component, data from the at least one data source, wherein the data comprises current user data; monitor, by the at least one virtual component, the data from the at least one data source; generate, in an instance after the monitoring of the data, encrypted data by applying an encryption layer to the data, wherein the encryption layer comprises at least one quantum-resistant encryption technique applied to the data; apply the encrypted data to an anomaly detection layer, wherein the anomaly detection layer comprises an artificial intelligence (AI) engine and a machine learning (ML) model; determine, by the ML model, an anomaly indicator based on whether an anomaly is present in the data based on the current user data; determine, by the AI engine, a prediction for the data based on the anomaly indicator and the current user data; and log, in a distributed ledger, the current user data and the anomaly indicator.

In some embodiments, and in an instance where the anomaly indicator comprises a positive anomaly indicator, the computer-readable code is configured to cause the at least one processing device to: determine at least one responsive user account based on the positive anomaly indicator, wherein the responsive user account is associated with historical responses to historical anomalies similar to the positive anomaly indicator; and trigger, in response to the positive anomaly indicator and the identification of the at least one responsive user account, a transmission of the positive anomaly indicator to at least one response user device associated with the at least one responsive user account.

In some embodiments, wherein executing the computer-readable code is configured to cause the at least one processing device to: determine at least one cryptographic key for the data; and apply the at least one cryptographic key to the data by a key management component. In some embodiments, executing the computer-readable code is configured to cause the at least one processing device to: apply the distributed ledger comprising the data to a cryptographic layer; and encrypt, by the cryptographic layer, the data with one or more cryptographic algorithms in the cryptographic layer, wherein the one or more cryptographic algorithms comprises at least one of a differential algorithm or secure computation algorithm. In some embodiments, executing the computer-readable code is configured to cause the at least one processing device to: apply the encrypted data from the cryptographic layer to a quantum resistant security layer; and generate, by the quantum resistant security layer, quantum resistant data from the encrypted data, wherein the quantum resistant security layer comprises at least one of a quantum key distribution or at least one quantum resistant algorithm. In some embodiments, executing the computer-readable code is configured to cause the at least one processing device to: allow access, via at least one application programming interface (API) gateway, by at least one response user device to the quantum resistant data.

In some embodiments, executing the computer-readable code is configured to cause the at least one processing device to: collect historical data associated with the at least one data source; generate a first training dataset comprising the historical data; train the ML model by applying the first training dataset to the ML model; identify the current user data from the data; apply the current user data to the trained ML model; and generate, by the trained ML model and based on the current user data, an initial anomaly indicator for the data of the data source. In some embodiments, executing the computer-readable code is configured to cause the at least one processing device to: determine, by the AI engine and based on the initial anomaly indicator for the data, the anomaly indicator of the data, wherein the anomaly indicator comprises a real time determination of anomalies and a prediction for anomalies in the at least one data source.

In some embodiments, the at least one virtual component comprises a virtual machine or a virtual container.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for securing data by detecting and preventing real-time data leakages in cloud environments, in accordance with an embodiment of the disclosure;

FIG. 2 illustrates an exemplary machine learning (ML) and artificial intelligence (AI) engine subsystem architecture, in accordance with an embodiment of the disclosure;

FIG. 3 illustrates a process flow for securing data by detecting and preventing real-time data leakages in cloud environments, in accordance with an embodiment of the disclosure;

FIG. 4 illustrates a process flow for triggering a transmission of the positive anomaly indicator to a response user device, in accordance with an embodiment of the disclosure;

FIG. 5 illustrates a process flow for applying encryption, cryptographic, and quantum techniques to the data from the at least one data source, in accordance with an embodiment of the disclosure;

FIG. 6 illustrates a flow diagram for generating initial anomaly indicators and determining the anomaly indicator using the ML model and AI engine, in accordance with an embodiment of the disclosure; and

FIG. 7 illustrates an exemplary architecture diagram for securing data by detecting and preventing real-time data leakages, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In today’s environment of using cloud computing and networked computing components, data transmissions have become more prevalent and integral to communications. Thus, enabling scalable, efficient, and secure data transmissions while preventing data leakages in real time and pro-actively has become more and more important. Such data leakages are a critical security concern which has only increased in frequency and importance as personal and identifying data is more widespread. Thus, a great need exists for a system that can efficiently, securely, and dynamically secure data by detecting and preventing real-time data leakages.

Accordingly, the present disclosure provides for the identification of at least one data source; the collection, by at least one virtual component, of data from the at least one data source, wherein the data comprises current user data; the monitoring, by the at least one virtual component, of the data from the at least one data source; the generation, in an instance after the monitoring of the data, of encrypted data by applying an encryption layer to the data, wherein the encryption layer comprises at least one quantum-resistant encryption technique applied to the data. Further, the disclosure provides for the application of the encrypted data to an anomaly detection layer, wherein the anomaly detection layer comprises an artificial intelligence (AI) engine and a machine learning (ML) model; the determination, by the ML model, of an anomaly indicator based on whether an anomaly is present in the data based on the current user data; the determination, by the AI engine, of a prediction for the data based on the anomaly indicator and the current user data; and a logging, in a distributed ledger, of the current user data and the anomaly indicator.

In some embodiments, the disclosure may further provide for determining at least one cryptographic key for the data; and applying the at least one cryptographic key to a key management component. In some further embodiments, the disclosure may provide for applying the distributed ledger comprising the data to a cryptographic layer; and encrypting, by the cryptographic layer, the data with one or more cryptographic algorithms in the cryptographic layer, wherein the one or more cryptographic algorithms comprises at least one of a differential algorithm or secure computation algorithm. The disclosure may additionally provide for applying the encrypted data from the cryptographic layer to a quantum resistant security layer; and generating, by the quantum resistant security layer, quantum resistant data from the encrypted data, wherein the quantum resistant security layer comprises at least one of a quantum key distribution or at least one quantum resistant algorithm. The disclosure may provide for allowing access, via at least one application programming interface (API) gateway, by at least one response user device to the quantum resistant data.

In other words, the disclosure provides a system for detecting and preventing data leakage in cloud environments. The invention comprises a comprehensive integration of virtual layers corresponding to cloud systems, encryption layers of the cloud systems and their data, artificial intelligence and machine learning to determine anomalies in data collected in real time from the cloud systems, a distributed ledger for logging the data and anomalies detected, and cryptographic algorithms for securing the data against future leaks and/or future cryptographic threats. The system further comprises a quantum resistant security layer comprising quantum key distribution and quantum resistant algorithms to prevent future quantum threats, where the data collected from the cloud systems may be protected pro-actively before the data is shown via API gateways for monitoring and incident responses.

What is more, the present disclosure provides a technical solution to a technical problem. As described herein, the technical problem includes the prevention and identification of data leakages. The technical solution presented herein allows for securing data by detecting and preventing real-time data leakages. In particular, the disclosure provided herein is an improvement over existing solutions to the identification and prevention of data leakages, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

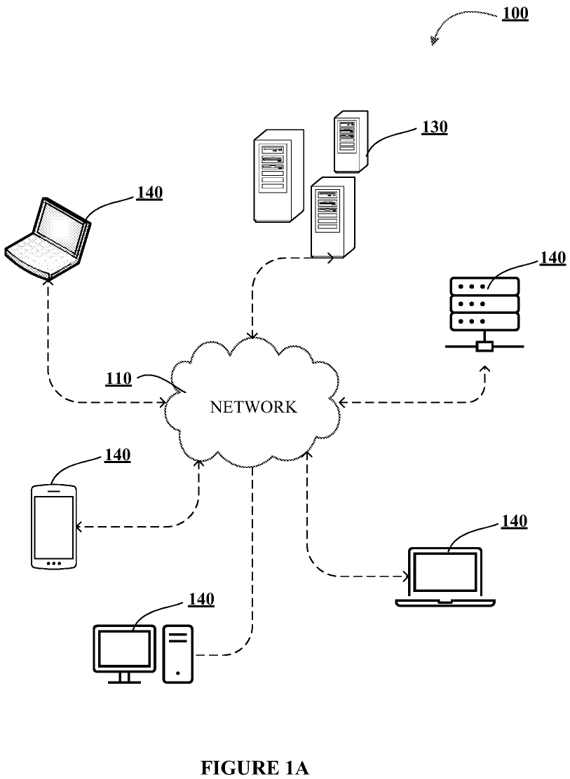

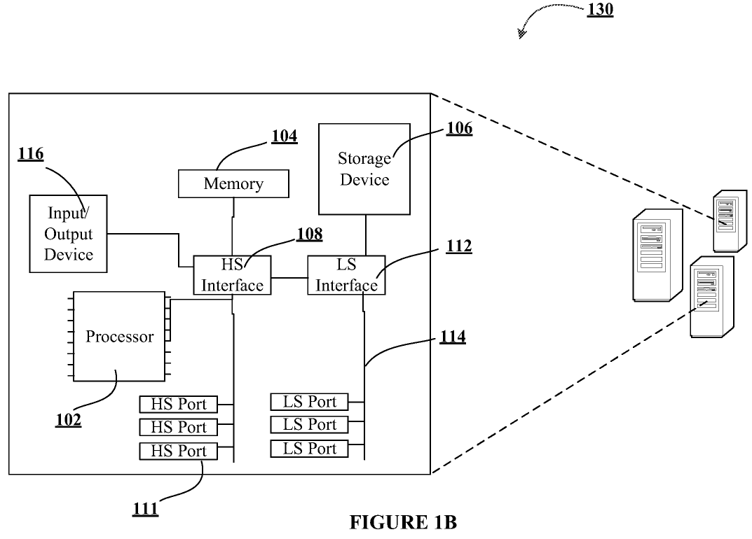

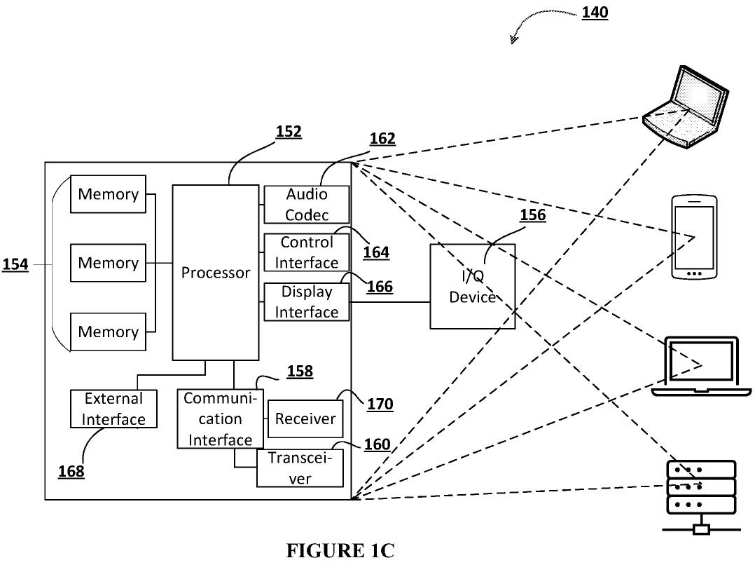

FIGS. 1A-1C illustrate technical components of an exemplary distributed computing environmentforsecuring databy detecting and preventing real-time data leakages in cloud environments 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low-speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation - and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

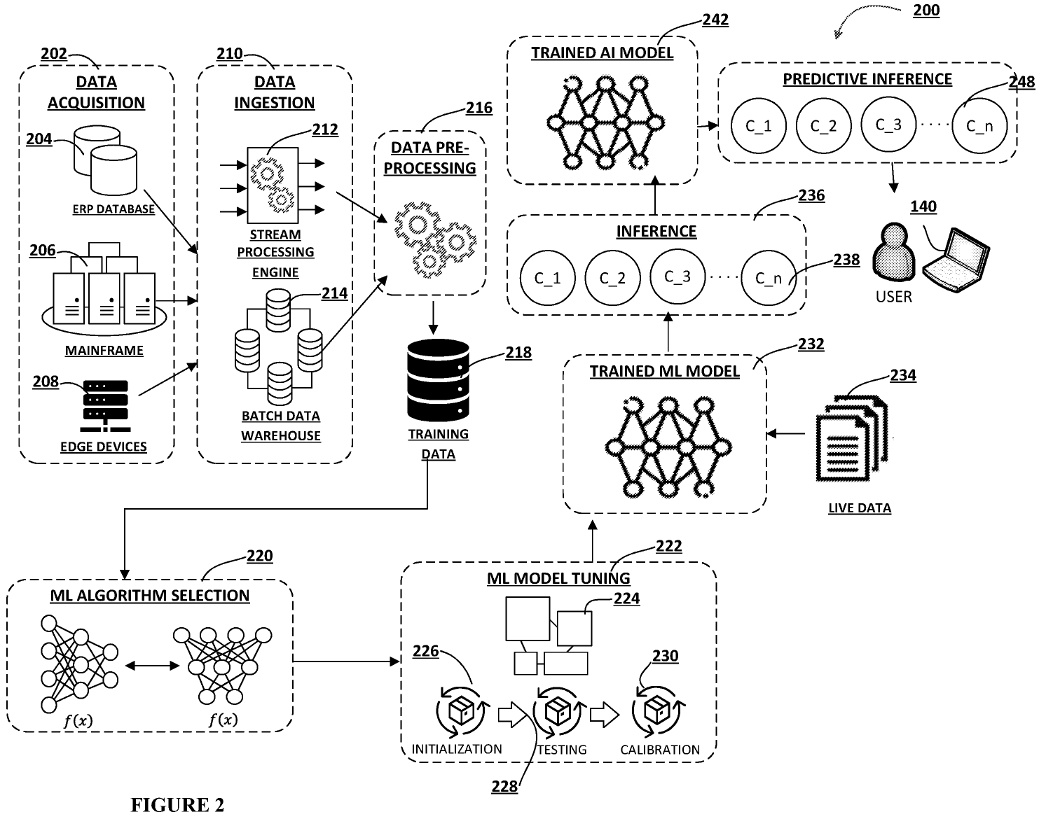

FIG. 2 illustrates an exemplary machine learning (ML) model and artificial intelligence (AI) engine subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity’s central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2...C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2...C_n 238) live data 234 based on how similar they are to one another to solve exploratory challenges where little is known about the data, provide a description or label (e.g., C_1, C_2...C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

Additionally, the output of inferences 238 from the trained AI model 242 may be applied to a trained AI model (also referred to herein as “trained AI engine”) which may be configured to and pre-trained to determine predictive inferences 248. Such a trained AI engine may use the same or similar framework as the architecture for training the ML model shown in FIG. 2 to train the AI engine 242. Further, the trained AI engine 242 may refine and enhance the inferences 238 generated by the ML model to determine predictions based on the data assessed by the ML model, make decisions on the data from the ML model, and/or the like.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

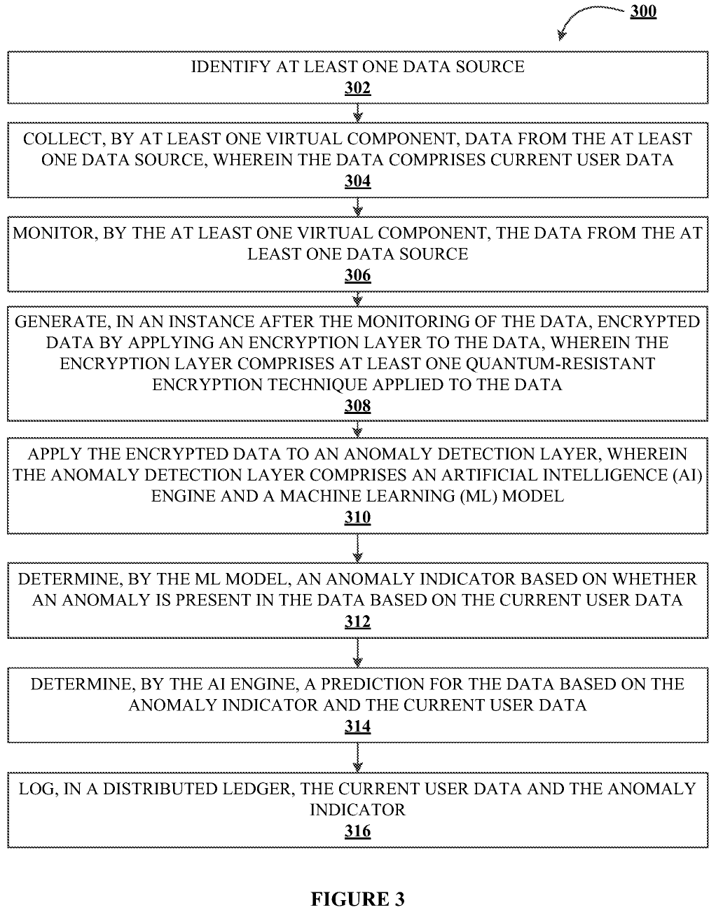

FIG. 3 illustrates a process flow 300 for securing data by detecting and preventing real-time data leakages in cloud environments, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIGS. 1A-1C) may perform the steps of process 300. In some embodiments, a machine learning (ML) model and/or artificial intelligence (AI) engine (like that shown and described with respect to FIG. 2) may perform some or all of the steps described in process flow 300.

As shown in block 302, the process flow 300 may include the step of identifying at least one data source. For instance, the data source referred to herein may comprise a cloud network(s), data storage component(s), device(s), application(s), and/or the like. Thus, and in some such embodiments, the data sources may store data, receive data, transmit data, generate data, use data, and/or the like. In some embodiments, the data sources may be identified by continuously monitoring the components and systems of a network associated with the system. In some embodiments, the at least one data source may be identified by a user of the system, such as a user that owns or manages one or more data sources that need to be identified for data potential data leakages. In some embodiments, the one or more data sources may be identified by the system itself based on past occurrences of data leakages that have been identified.

As shown in block 304, the process flow 300 may include the step of collecting, by at least one virtual component, data from the at least one data source, wherein the data comprises current user data. For example, the virtual component may comprise a virtual machine, virtual container, and/or the like. In some embodiments, the blocks described herein may occur within one or more layers of virtualization. For instance, and in some embodiments, the process described herein may integrate virtual machines, containers, and/or microservices for granular monitoring and enhanced security across complex network environments and/or complex cloud environments.

In some embodiments, the system may collect data from the at least one data source, and this collection may include current user data such as but not limited to data or information of how a user is using the data, where the data has/is being transmitted, historical user data, current user data regrading data transmissions, data access requests, keystrokes, timestamps for requests and keystrokes, application usages, how the network is accessed, user device interactions, and/or the like. In some embodiments, the historical user data may comprise historical information or data on how data was used, how the network has been accessed in the past, user interactions at the data source(s) in the past, historical access requests, historical keystrokes, historical timestamps, historical application usages, and/or the like.

As shown in block 306, the process flow 300 may include the step of monitoring, by the at least one virtual component, the data from the at least one data source. For example, the system may monitor by continuously monitoring, or collecting at pre-determined intervals, data from the one or more data sources. Such monitoring may occur in parallel to the collection of the data or before the collection of the data from the at least one data source. Thus, and in some embodiments, the blocks shown as block 304 and 306 may be interchangeable in the process flow 300.

As shown in block 308, the process flow 300 may include the step of generating, in an instance after the monitoring of the data, encrypted data by applying an encryption layer to the data, wherein the encryption layer comprises at least one quantum-resistant encryption technique applied to the data. For instance, the encryption layer may comprise quantum resistant cryptography techniques and/or secure key management system to protect data against current and/or future cryptographic threats. In some embodiments, the encryption layer may comprise multiple encryption layers and/or encryption data flows that are configured to apply multiple encryption techniques to the monitored and collected data. In some embodiments, the multi-layered encryption may comprise applying multiple encryption algorithms to the data, using distinct encryption algorithms or keys from a key management service, where such a multi-layered encryption ensures enhanced security and a lesser likelihood of unauthorized decryption of the underlying data.

In some embodiments, the quantum-resistant encryption technique comprises one or more quantum-resistant cryptographic techniques. Such quantum-resistant cryptographic techniques may comprise cryptographic algorithms that are secure against current and future classical and quantum computers. In some embodiments, these quantum-resistant encryption techniques may comprise symmetric (e.g., the same key for encryption and decryption) or asymmetric cryptography (e.g., different keys for encryption and decryption), lattice-based cryptography, code-based cryptography, multivariate cryptography, hash-based cryptography, isogeny-based cryptography, and/or the like. In some embodiments, the system may apply the quantum-resistant encryption techniques to the data and generate the encrypted data from the data.

As shown in block 310, the process flow 300 may include the step of applying the encrypted data to an anomaly detection layer, wherein the anomaly detection layer comprises an artificial intelligence (AI) engine and a machine learning (ML) model. For example, the anomaly detection layer may be used to detect and/or respond to anomalies (i.e., which may indicate data leakages) in real time or near real time, which enhances proactive data security. Such an anomaly detection layer may use a combination of at least one ML model and at least one AI engine to analyze current user data, and in some instances historical user data, to determine anomalies in the current user data. Such an ML is like that shown and described above with respect to FIG. 2.

In some embodiments, the ML model may be configured to receive the data (in either its base form or in its encrypted format), analyze the data, and output an anomaly indicator. In some embodiments, the anomaly indicator may comprise an initial determination of whether an anomaly is present in the data. In some embodiments, the ML model may be trained on specific user data (e.g., historical user data), such that the ML model may determine when an anomaly is likely present based on the specific current user data as compared to historical user data (for the same user, or a similar user). In some embodiments, the ML model may be configured to continuously monitor user behavior via the user data, network traffic data, and every data access and transaction (e.g., the current user data) to detect anomalies indicative of potential data leakages. Further, and by combining an AI engine with the ML model, the anomaly indicator can be further enriched or enhanced by the AI engine by applying deep learning and predictive analysis to determine a prediction with the anomaly indicator described below. Such an AI engine as that used herein is described in further detail above with respect to FIG. 2.

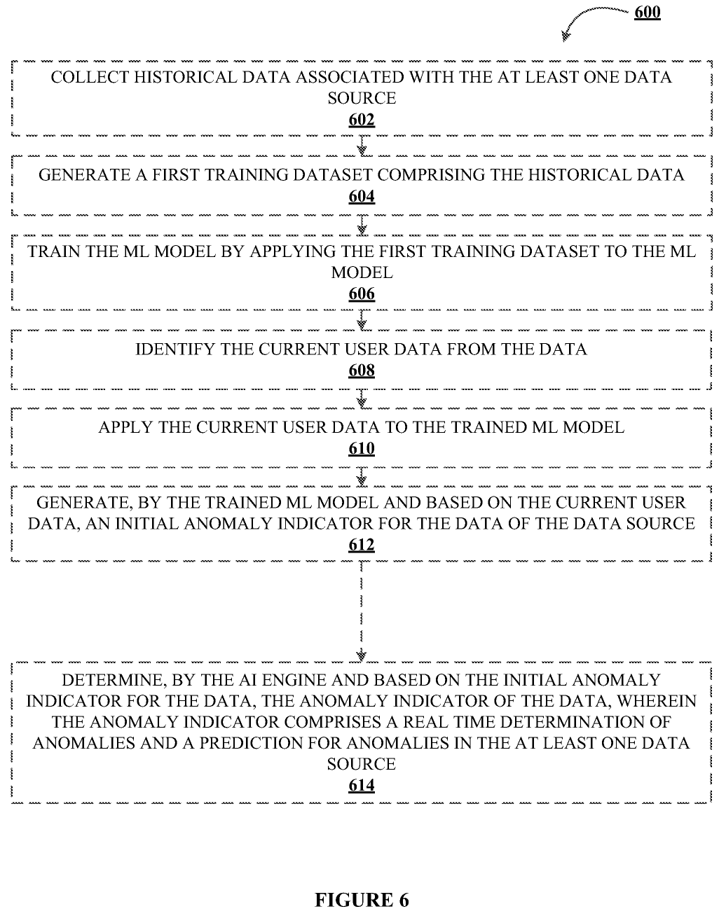

In some embodiments, the ML model may be configured to generate a pre-anomaly indicator, and the AI engine may be configured to enrich the pre-anomaly indicator to determine the anomaly indicator along with a prediction for future data leakages based on the current user data and the anomaly indicator. In this manner, the AI engine may be configured to receive the output of the ML model, enrich the output from the ML model and generate a more complex output of the output from the ML model or an enriched anomaly indicator that indicates a higher likelihood of being true. Such an embodiment is described in further detail below with respect to FIG. 6.

As shown in block 312, the process flow 300 may include the step of determining, by the ML model, an anomaly indicator based on whether an anomaly is present in the data based on the current user data. For example, and as described briefly above, the system may comprise an ML model configured with an AI engine, and the ML model may be trained and configured to determine whether the presence of an anomaly is present in the data being monitored and collected from the one or more data sources. Thus, in an instance where an anomaly is detected, the system—via the ML model—may determine the anomaly indicator is positive, and thus, a data leakage is likely present. In another instance, and where the system determines an anomaly is not present in the data, the anomaly indicator may be determined to be negative, and thus, a data leakage is likely not present.

In some embodiments, the ML model may be pre-trained on historical user data and/or historical data associated with the at least one data resource. In some embodiments, the historical user data may be data source specific, user specific, and/or the like. In some embodiments, the historical user data may comprise historical data that is not user specific, but may only be data source specific (e.g., may be general data across multiple users or all users of the data sources). In some embodiments, the historical user data may comprise historical data of a plurality of users and a plurality of data sources, such that the historical data is general to the network environment.

Further, and in some embodiments, the ML model may receive the data (e.g., the current user data as the user interacts with the at least one data source) as an input, and the ML model may generate an anomaly indicator based on comparing the current user data to the patterns from the historical user data/historical data and determining the presence of anomalies in the current user data. In some instances, such anomalies may indicate the presence of a data leakage or data security threat.

As shown in block 314, the process flow 300 may include the step of determining, by the AI engine, a prediction for the data based on the anomaly indicator and the current user data. For example, and as described briefly above, the system may additionally comprise an AI engine working in combination with the ML model. Such an AI engine may be configured to enhance the ML model’s determination of anomalies by further generating predictions based on the anomalies and the current user data. In this manner, the AI engine may comprise predictive analysis techniques and deep learning techniques to assess the current user data, the anomalies detected by the ML model (in the instances where anomalies are detected) and determine a future prediction of data leakages and data security threats. In some embodiments, the AI engine may be trained with the same or similar data as the ML model. For example, and in some such embodiments, the AI engine may be trained with historical user data, historical data, and/or the like. In some embodiments, the AI engine may comprise the ML model as a component of the AI engine.

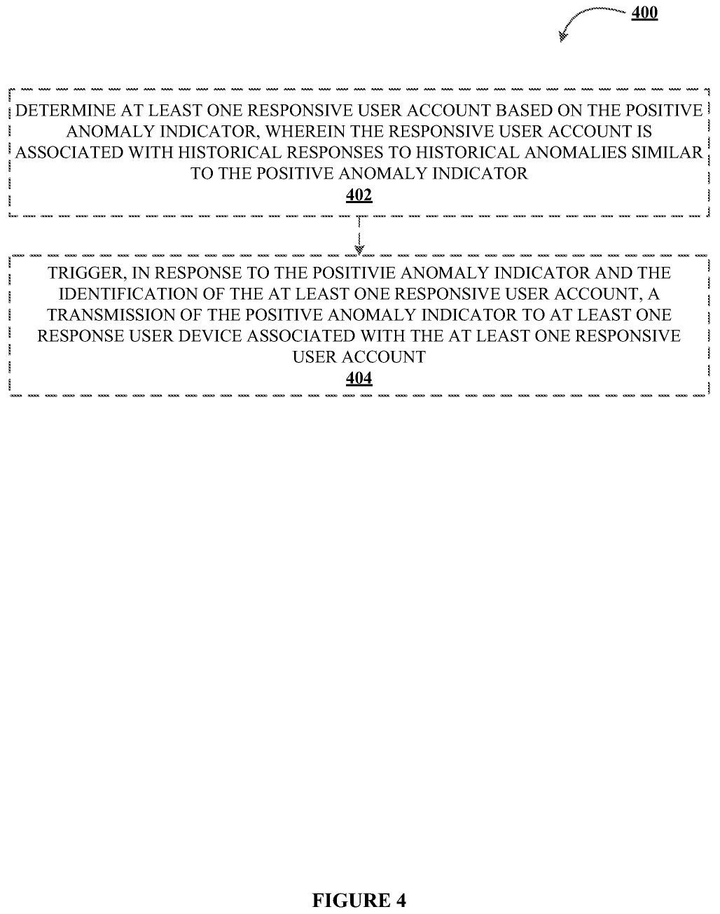

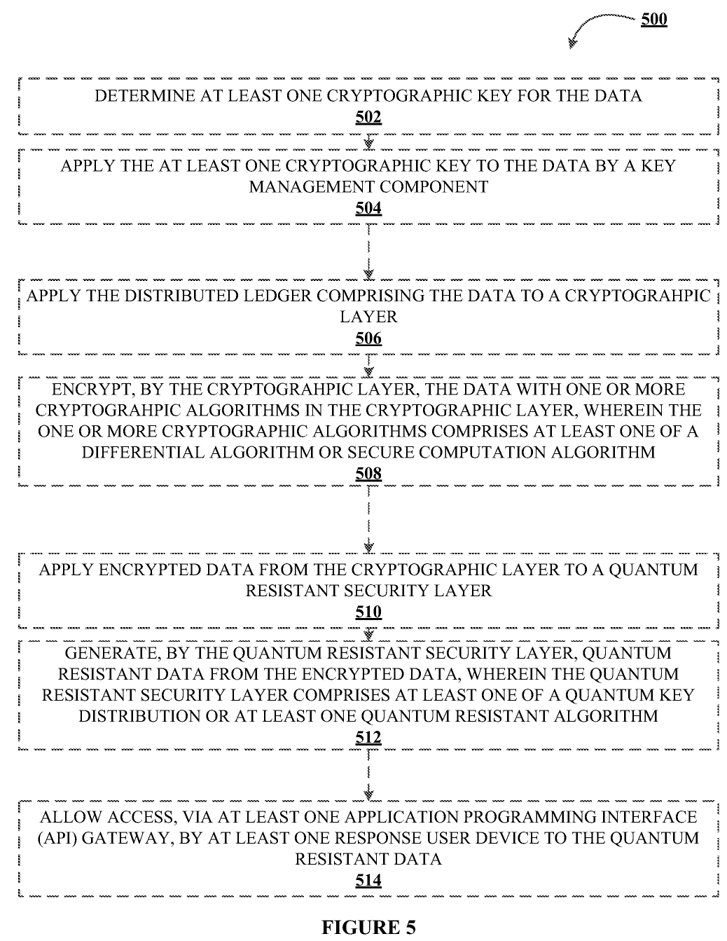

As shown in block 316, the process flow 300 may include the step of logging, in a distributed ledger, the current user data and the anomaly indicator. For example, the system may log all the data monitored and collected, encrypted, including the current user data and the determined anomaly indicator to a distributed ledger associated with the data source the data was received from. In such an embodiment, each distributed ledger may be specific to each data source, and thus, the system may separately log each instance of data monitored and collected, encrypted, and anomaly indicator determined to a specific distributed ledger associated with the appropriate data source identifier. In this manner, and importantly, the system may allow for secure logging of data from the data source(s), while maintaining a complete record of each piece of data and each instance of the anomaly indicators determined by the system (e.g., positive and/or negative). In such an embodiment, the system may ensure an immutable layer using the distributed ledger to record critical events using this immutable ledger and, in some embodiments, smart contracts for automated remediation where anomalies are detected. Such an embodiment for automated remediation is discussed below with respect to FIGS. 4 and 5.

FIG. 4 illustrates a process flow 400 for triggering a transmission of the positive anomaly indicator to a response user device, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIGS. 1A-1C) may perform the steps of process 400. In some embodiments, a machine learning (ML) model and/or artificial intelligence (AI) engine (like that shown and described with respect to FIG. 2) may perform some or all the steps described in process flow 400.

In some embodiments, and as shown in block 402, the process flow 400 may include the step of determining at least one responsive user account based on a positive anomaly indicator, wherein the responsive user account is associated with historical responses to historical anomalies similar to the positive anomaly indicator. For example, and in some such embodiments, the responsive user account may comprise a user account associated with a user that can resolve the underlying problem that generated the anomaly (the data leakage), and/or that can resolve any problems that may be an outcome of the anomaly. For example, the responsive user account may be identified by the system based on historical anomalies that have been resolved or addressed by the responsive user account. In some such embodiments, the historical responses to the historical anomalies may be determined as similar to the current anomalies based on shared attributes, such as but not limited to sharing the same data source(s), the same anomaly type, the same outcomes of the anomaly, and/or the like. In some embodiments, the system may access a database or index comprising responsive user account identifiers that are associated with or linked with historical anomaly types.

Thus, and in some such embodiments, the system may identify the responsive user account that has resolved a historical anomaly type of the same type as the current anomaly based on accessing the database or index and transmitting the positive anomaly indicator to the recipient user account’s user device. Therefore, and in some such embodiments, the positive anomaly indicator may comprise data regarding the anomaly type (e.g., human error, insider threat, technical vulnerability, cyberattack, social engineering, and/or the like). Such an anomaly type may be determined by the ML model and/or the AI engine based on pre-training of the ML model and/or the AI engine on historical anomaly types.

In some embodiments, the distributed ledger may comprise at least one smart contract which may automatically determine the responsive user account to transmit the anomaly indicator to the responsive user account’s user device for automatic remediation. Thus, and in some such embodiments, the smart contract may be used to automatically transmit a report to the correct response team or to automatically deploy a solution to the data source such as a blocking of user interactions, blocking of user accounts, isolation of any further user interactions into a simulated environment, and/or the like.

In some embodiments, and as shown in block 404, the process flow 400 may include the step of triggering, in response to the positive anomaly indicator and the identification of the at least one responsive user account, a transmission of the positive anomaly indicator to at least one response user device associated with the at least one responsive user account. For example, such a transmission (over a network) may comprise transmitting the positive anomaly indicator to at least one response user device associated with the at least one identified responsive user account. In some embodiments, a plurality of responsive user accounts that can resolve the anomaly may be identified in real time or near real time, and the system may automatically trigger the transmission of the positive anomaly indicator to the plurality of response user devices associated with the plurality of responsive user accounts. Thus, and in some such embodiments, the positive anomaly may be resolved as quickly as possible by at least one of the responsive user accounts. In some embodiments, the responsive user accounts may be prioritized based on a current workload of all the responsive user accounts that can resolve the anomaly, where the top-most responsive user account may be identified as the responsive user account with the least current workload.

FIG. 5 illustrates a process flow 500 for applying encryption, cryptographic, and quantum techniques to the data from the at least one data source, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIGS. 1A-1C) may perform the steps of process 500. In some embodiments, a machine learning (ML) model and/or artificial intelligence (AI) engine (like that shown and described with respect to FIG. 2) may perform some or all the steps described in process flow 500.

In some embodiments, and as shown in block 502, the process flow 500 may include the step of determining at least one cryptographic key for the data. For example, and in some embodiments, such a cryptographic key may be used to encrypt the data from the one or more data sources. In some embodiments, the cryptographic key may be symmetric, asymmetric, public keys, private keys, a session or temporary key, signature key, authentication key, derived key, and/or the like. In some embodiments, the data may be encrypted at multiple levels or layers with multiple cryptographic keys. In some embodiments, the cryptographic key(s) may be generated and then applied to the data in a step-by-step manner by applying an encryption algorithm(s) to the data and one or more cryptographic keys. In some embodiments, the determination of the cryptographic key may be based on a key management system (KMS) generating and applying the cryptographic key to the data along with the encryption algorithm.

In some embodiments, and as shown in block 504, the process flow 500 may include the step of applying the at least one cryptographic key to the data by a key management component. Thus, and in some embodiments, upon applying the data as an input to the encryption algorithm(s), the system may also apply one or more cryptographic keys from a KMS, whereby the KMS may be configured to generate, store, and manage the lifecycle of each of the cryptographic keys associated with the system. In some embodiments, and upon determining the cryptographic key(s), the system may use a key management system to store and securely manage the cryptographic keys. Thus, and as used herein, the key management component refers to a key management system configured to generate, organize, distribute, store, manage, and/or the like, cryptographic keys used for encryption and decryption.

In some embodiments, and as shown in block 506, the process flow 500 may include the step of applying the distributed ledger comprising the data to a cryptographic layer. In some embodiments, the process described herein with respect to blocks 506 and 508 may occur immediately after the process described herein with respect to blocks 502 and 504. However, in some other embodiments, the process described herein with respect to blocks 506 and 508 may occur later and not immediately after the process of blocks 502 and 504. For example, the process described herein with respect to blocks 506 and 508 may occur immediately after the process of FIG. 3 (e.g., after the distributed ledger has been logged and updated in block 316).

In some embodiments, and as shown in block 508, the process flow 500 may include the step of encrypting, by the cryptographic layer, the data with one or more cryptographic algorithms in the cryptographic layer, wherein the one or more cryptographic algorithms comprises at least one of a differential algorithm or secure computation algorithm. In some embodiments, the secure computation algorithm refers to a secured multi-party computations (SMPC). For example, and in some embodiments, the system may apply the distributed ledger to the cryptographic layer, whereby the cryptographic layer is configured to allow secured multi-party computations (SMPC) and/or differential privacy. For instance, the system enables secure, privacy-preserving data collaboration and analysis, safeguarding sensitive information during processing. For example, the SMPC refers to a cryptographic technique that allows multiple parties to jointly compute a function on their private inputs without revealing those inputs to the other parties. Thus, the SMPC allows parties to use cryptographic techniques to perform computations on their private inputs, before providing the output to the other parties with the cryptography technique applied such that the other parties cannot determine the underlying input.

Additionally, and/or alternatively, the cryptographic layer may comprise differential privacy algorithms that are configured to protect the sensitive data from the one or more data sources by adding noise to the data and ensuring the difficulty in a user, system, and/or the like, being able to distinguish between datasets and the noise. In some embodiments, the differential privacy algorithm may dynamically change the amount of noise added based on the algorithm’s sensitivity when a new data point is added or modified and how much the output changes. Thus, the differential privacy algorithm’s noise may increase as the sensitivity increases to ensure privacy. In some embodiments, the differential privacy algorithm may comprise a Laplace technique to add Laplace noise, wherein the Laplace noise may increase based on the sensitivity of the algorithm and the desired level of privacy for the data (e.g., the greater the need for privacy, the greater the noise needed).

In some embodiments, the cryptographic layer may comprise secure enclaves, wherein the secure enclaves are a dedicated, secure hardware component that protects sensitive data by providing a trusted execution environment, and safeguarding computation from unauthorized access. In some embodiments, the SMPC, the differential privacy algorithm(s), and/or the secure enclaves may all work in concert with each other to provide protections to the data from the distributed ledger and/or data directly from the one or more data sources. In some embodiments, one or more of the SMPC, the differential privacy algorithm(s), and/or the secure enclaves may be used individually or in combination to protect the data in the distributed ledger and/or from the one or more data sources.

In some embodiments, and as shown in block 510, the process flow 500 may include the step of applying encrypted data from the cryptographic layer to the quantum resistant security layer. For example, the system may additionally comprise a quantum resistant security layer that may comprise a quantum resistant algorithm(s) and/or quantum key distribution. Such a quantum resistant security layer may be configured to secure the data from the cryptographic layer from quantum computing attacks and classical computers.

In some embodiments, and as shown in block 512, the process flow 500 may include the step of generating, by the quantum resistant security layer, quantum resistant data from the encrypted data, wherein the quantum resistant security layer comprises at least one quantum key distribution or at least one quantum resistant algorithm. For example, the quantum resistant data may be generated by the quantum resistant security layer from the data of encrypted data of the cryptographic layer. In this manner, the quantum resistant data may be the output generated by the quantum resistant security layer after processing of the encrypted data as an input.

In some embodiments, the quantum resistant data may be generated by at least one quantum resistant algorithm using the output from the cryptographic layer as an input. Such quantum resistant algorithms may comprise lattice-based cryptographic algorithms, hash-based cryptographic algorithms, code-based cryptographic algorithms, multivariate cryptographic algorithms, and/or the like. Thus, and by applying one or more of these quantum resistant algorithms to the encrypted data, the quantum resistant security layer may generate the quantum resistant data.

Additionally, and/or alternatively, the quantum resistant data may be generated using at least one quantum key distribution (QKD) technique. For example, the quantum key distribution techniques refer to methods or mechanisms for securely generating and sharing cryptographic keys using quantum mechanics. Similarly to the KMS described above, the QKD may use quantum states of photons and light to generate and distribute random keys to the transferor of the data and the recipient of the data that can be used to encrypt and decrypt the data securely. Further, and importantly, if a man in the middle attack occurs and the key is intercepted or eavesdropped, the use of these quantum keys ensures that any interception or unsanctioned access/eavesdropping causes the quantum key’s photon properties to be disturbed, and the quantum key may no longer be used. Thus, and in some such embodiments, the quantum resistant security layer may use the QKD techniques to generate quantum keys for the encrypted data from the cryptographic layer and/or for any other portion of the data herein described throughout the processes of FIGS. 3 and 4. In some embodiments, the quantum keys may be send to one or more users within the network associated with the system, such as but not limited to users associated with one or more responsive user accounts. Thus, and in some such embodiments, the quantum keys may be used by the one or more responsive users of the responsive user accounts to access the encrypted data and any other such quantum resistant protected data using the QKD techniques described herein.

As a person of skill in the art will understand, each of the processes described herein for protecting data, logging data, securing data, and/or identifying data leakages may be applied to any of the data received from the one or more data sources no matter the protections, logging, security, that has already been applied to the data. Thus, and in other words, the multi-layered processes of applying data security protocols described herein and logging of data in distributed ledgers may occur at any time and are not limited to the flow of steps described and shown herein.

In some embodiments, and as shown in block 514, the process flow 500 may include the step of allowing access, via at least one application programming interface (API) gateway, by at least one response user device to the quantum resistant data. As used herein, the API gateway refers to an API tool for managing requests and calls received via the API, whereby the API gateway acts as an entry point for applications to access at least one backend services while also routing requests, ensuring securing and load balancing network traffic across the backend services and instances. In this manner, the API gateway acts as a single-entry point for all requests between applications and/or user devices and the backend processes (e.g., accessing data indicating the data leakages and/or the applications or data sources associated with the identified data leakages) by one or more response user devices.

In some embodiments, the API gateway(s) may be configured to ensure identity and access management for the users requesting access to the data protected by encryption, cryptography, and/or quantum keys/quantum cryptography. The API gateway(s) may perform this identity and access management by authenticating, authorizing, and/or controlling access to only pre-authorized users can access the back-end services. In some embodiments, the API gateway authenticates the users for accessing the services based on pre-authenticated response user accounts for the one or more data sources and/or the anomaly indicators/anomaly indicator types. Such pre-authenticated response user accounts may be identified based on response user account identifiers which may uniquely identify each user account. Additionally, using this API gateway, the system may also automatically deny access to one or more user devices and/or applications to the backend services. For example, the API gateway may likewise be configured to deny or block access to those user devices and/or applications that are not pre-authorized to access the backend services, individually based on each specific back-end service or for all backend services in a network.

In some embodiments, the API gateway(s) may be configured with secure communication channels by implementing encryption techniques between the requests and the API gateway, which ensures eavesdropping and man in the middle attacks cannot occur. Further, the API gateway(s) may comprise authorization methods for authenticating the response user accounts, and/or API keys that can be applied with the requests from the response user devices to authenticate the responsive user accounts. Such API keys may be used to authenticate the responsive user accounts and limit the number of accesses to the backend service.

In some embodiments, the API gateway(s) may be configured to comprise cross-domain protocols, and these cross-domain protocols may refer to a security mechanism for allowing web applications to access resources/data from different domains. In this manner, the API gateway(s) may allow access to one or more response user devices to different domains that may house the different data sources, different domains that may house different distributed ledgers, and/or the like.

FIG. 6 illustrates a process flow 600 for generating initial anomaly indicators and determining the anomaly indicator using the ML model and AI engine, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIGS. 1A-1C) may perform the steps of process 600. In some embodiments, a machine learning (ML) model and/or artificial intelligence (AI) engine (like that shown and described with respect to FIG. 2) may perform some or all of the steps described in process flow 600.

In some embodiments, and as shown in block 602, the process flow 600 may include the step of collecting historical data associated with the at least one data source. For example, and in some such embodiments, the historical data may comprise historical data from each of the data sources within the network and/or from a specific set of data sources that are being analyzed by the system for data leakages. Such historical data may comprise data regarding user interactions with the data sources, data transmissions by and to the data sources, data stored and/or used by the data sources (such as personally identifying data, sensitive data, and/or the like), keystroke and mouse data (e.g., frequency data), and/or the like. In some embodiments, the historical data may comprise historical user data that is specific to a specific user interacting with the data sources. Thus, and in some such embodiments, the historical user data may be collected and used to train the ML model and/or the AI engine specifically to one or more user accounts and their historic interactions with the data sources. Additionally, and/or alternatively, the historical data collected may comprise historical user data across multiple users or all users that have interacted with the data sources associated with the system. In some embodiments, the historical data may further comprise data showing anomalies indicating data leakages.

In some embodiments, the system may collect this historical data from a database of user data, from the data source(s) itself, and/or the like. Thus, and in some embodiments, the database of user data may be stored and updated by the system itself, by a system external to the system described herein, and/or the like.

In some embodiments, and as shown in block 604, the process flow 600 may include the step of generating a first training dataset comprising the historical data. For example, the system may generate—using the collected historical data—at least one training dataset to train the ML model and/or the AI engine. In some embodiments, the system may generate a plurality of training datasets, where each training dataset is generated as historical data is collected continuously or at iterative periods. For example, and as data is collected, the data may be labeled as historical data as the anomaly indicators are determined and new current data is collected and analyzed by to determine new/current anomaly indicators.

In some embodiments, and as shown in block 606, the process flow 600 may include the step of training the ML model by applying the first training dataset to the ML model. For instance, and in some such embodiments, the system may apply the at least one training dataset (e.g., the first training dataset, secondary training dataset, and/or later training datasets) as an input to the ML model and/or the AI engine to train the ML model and/or the AI engine. In this manner, the ML model may be trained on the historical data to make connections and determine patterns between the historical data and anomalies indicating data leakages. Similarly, the AI engine may be trained to enhance the anomalies/data leakages determinations of the data sources and to make predictions regarding the data leakages.

In some embodiments, and as shown in block 608, the process flow 600 may include the step of identifying the current user data from the data. For example, and in some embodiments, the system may identify the current user data from the data of the one or more data sources. In some embodiments, the system may identify the current user data by parsing the data collected from the one or more data sources, determine which data is associated with interactions by a user with the one or more data sources (e.g., data transmissions, keystrokes, key inputs, data accesses, and/or the like).

In some embodiments, and as shown in block 610, the process flow 600 may include the step of applying the current user data to the trained ML model. For instance, and in some embodiments, the system may apply the current user data to the trained ML model and/or the trained AI engine to determine whether a data leakage has likely occurred and to determine the anomaly indicator.

In some embodiments, and as shown in block 612, the process flow 600 may include the step of generating, by the trained ML model and based on the current user data, an initial anomaly indicator for the data of the data source. For example, and in some embodiments, the system—using the ML model and/or the AI engine—may generate the anomaly indicator or an initial anomaly indicator for the data source(s). In some embodiments, the initial anomaly indicator may be generated by the ML model and the initial anomaly indicator may comprise an initial determination of the presence of a data leakage. Additionally, and only after the AI engine has processed the output data from the ML model, may the anomaly indicator be generated as an enhanced version of the initial anomaly indicator. In some embodiments, the ML model may generate the anomaly indicator, and the AI engine may determine a prediction for the data with which may be combined with the anomaly indicator for the data leakage determination.

In some embodiments, and as shown in block 614, the process flow 600 may include the step of determining, by the AI engine and based on the initial anomaly indicator for the data, the anomaly indicator of the data, wherein the anomaly indicator comprises a real time determination of anomalies and a prediction for anomalies in the at least one data source. For instance, the system may determine the anomaly indicator as the final anomaly indicator that will be stored in the distributed ledger and used as to identify the data leakage to the system and/or to the responsive user account(s). Further, and in some embodiments, the anomaly indicator may comprise a real time determination or near real time determination of the anomalies (the data leakages and/or the non-data leakages). Thus, the anomaly indicators determined may be determined in real time or near real time to receiving the current data from the one or more data sources.

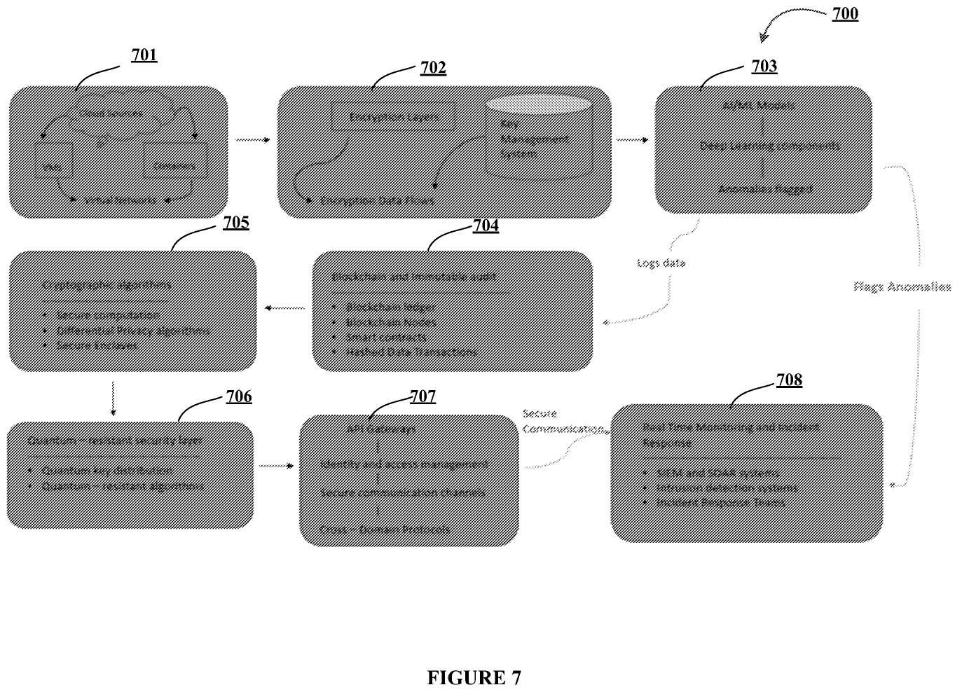

FIG. 7 illustrates an exemplary architecture diagram 700 for securing data by detecting and preventing real-time data leakages in cloud environments, in accordance with an embodiment of the disclosure. In some embodiments, a system (e.g., similar to one or more of the systems described herein with respect to FIGS. 1A-1C) may perform one or more of the steps of architecture diagram 700. For example, a system (e.g., the system 130 described herein with respect to FIGS. 1A-1C) may perform the steps of architecture diagram 700. In some embodiments, a machine learning (ML) model and/or artificial intelligence (AI) engine (like that shown and described with respect to FIG. 2) may perform some or all the steps described in architecture diagram 700.

As shown in diagram 700, the process for securing data by detecting and preventing real-time data leakages in cloud environments may begin with identifying one or more data sources (e.g., cloud services) and collecting data from the one or more data sources by a virtual machine, virtual container, and/or the like at step 701. Further, and as shown in step 702, the system may additionally generate encrypted data by applying the encryption layer 702 to the collected and monitored data of step 701. Such an encryption layer may comprise a key management system (KMS) and various encryption algorithms which may be used to generate the encrypted data in a step-by-step manner (e.g., using encryption data flows to layer encryption to the data monitored and collected).

Additionally, and as shown in step 703, the system may use a combination of AI and ML to determine anomalies within the data from the one or more data sources. Such an AI/ML model and engine may comprise deep learning components for flagging anomalies and transmitting any flagged anomalies directly to response user devices associated with responsive user accounts, like the real time incident response teams of step 708.

Additionally, and as shown in block 704, the system may log these anomalies and the underlying data on a distributed ledger as an immutable auditing tool. Such a distributed ledger may further comprise smart contracts and hashed data transactions for proper logging and instant or near real time remediation of the anomalies.

Additionally, and as shown in step 705, the system may use a cryptographic layer comprising cryptographic algorithms to cryptographically protect the data from unauthorized access or decryption. In some embodiments, the cryptographic algorithms may be applied to the distributed ledger of step 704 to protect the data within each block. Such cryptographic algorithms may comprise secure computation (SPMC), differential privacy algorithms, secure enclaves, and/or the like.

In some embodiments, the system may additionally comprise a quantum resistant security layer 706, this quantum resistant security layer 706 may be configured with quantum key distribution (QKD) and/or quantum resistant algorithms to protect the data within this system from classical and quantum attacks.

Additionally, and upon securing the data and anomalies, the system may comprise API gateways 707 to allow requests for the data from one or more response user devices, applications, and/or the like. Such API gateways 707 may comprise identity and access management controls, secure communication channels, and cross-domain protocols to ensure protection of the data during transmission and accessing by outside users and user devices (e.g., like that shown in step 708). For example, step 708 comprises real time monitoring and incident response by a security information and event management (SIEM) network of users and/or security orchestration and automation response (SOAR) teams that can resolve the data leakages and any outcomes of the data leakages/anomalies.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for securing data by detecting and preventing real-time data leakages in cloud environments, the system comprising:
a memory device with computer-readable program code stored thereon;
at least one processing device operatively coupled to the memory device and at least one communication device, wherein executing the computer-readable code is configured to cause the at least one processing device to:
identify at least one data source;
collect, by at least one virtual component, data from the at least one data source, wherein the data comprises current user data;
monitor, by the at least one virtual component, the data from the at least one data source;
generate, in an instance after the monitoring of the data, encrypted data by applying an encryption layer to the data, wherein the encryption layer comprises at least one quantum-resistant encryption technique applied to the data;
apply the encrypted data to an anomaly detection layer, wherein the anomaly detection layer comprises an artificial intelligence (AI) engine and a machine learning (ML) model;
determine, by the ML model, an anomaly indicator based on whether an anomaly is present in the data based on the current user data;
determine, by the AI engine, a prediction for the data based on the anomaly indicator and the current user data; and
log, in a distributed ledger, the current user data and the anomaly indicator.

2. The system of claim 1, wherein the anomaly indicator comprises a positive anomaly indicator, and wherein executing the computer-readable code is configured to cause the at least one processing device to:
determine at least one responsive user account based on the positive anomaly indicator, wherein the responsive user account is associated with historical responses to historical anomalies similar to the positive anomaly indicator; and
trigger, in response to the positive anomaly indicator and the identification of the at least one responsive user account, a transmission of the positive anomaly indicator to at least one response user device associated with the at least one responsive user account.

3. The system of claim 1, wherein executing the computer-readable code is configured to cause the at least one processing device to:
determine at least one cryptographic key for the data; and
apply the at least one cryptographic key to the data by a key management component.

4. The system of claim 3, wherein executing the computer-readable code is configured to cause the at least one processing device to:
apply the distributed ledger comprising the data to a cryptographic layer; and
encrypt, by the cryptographic layer, the data with one or more cryptographic algorithms in the cryptographic layer, wherein the one or more cryptographic algorithms comprises at least one of a differential algorithm or secure computation algorithm.

5. The system of claim 4, wherein executing the computer-readable code is configured to cause the at least one processing device to:
apply the encrypted data from the cryptographic layer to a quantum resistant security layer; and
generate, by the quantum resistant security layer, quantum resistant data from the encrypted data, wherein the quantum resistant security layer comprises at least one of a quantum key distribution or at least one quantum resistant algorithm.

6. The system of claim 5, wherein executing the computer-readable code is configured to cause the at least one processing device to:
allow access, via at least one application programming interface (API) gateway, by at least one response user device to the quantum resistant data.

7. The system of claim 1, wherein executing the computer-readable code is configured to cause the at least one processing device to:
collect historical data associated with the at least one data source;
generate a first training dataset comprising the historical data;
train the ML model by applying the first training dataset to the ML model;
identify the current user data from the data;
apply the current user data to the trained ML model; and
generate, by the trained ML model and based on the current user data, an initial anomaly indicator for the data of the data source.

8. The system of claim 7, wherein executing the computer-readable code is configured to cause the at least one processing device to:
determine, by the AI engine and based on the initial anomaly indicator for the data, the anomaly indicator of the data, wherein the anomaly indicator comprises a real time determination of anomalies and a prediction for anomalies in the at least one data source.

9. The system of claim 1, wherein the at least one virtual component comprises a virtual machine or a virtual container.

10. A computer program product for securing data by detecting and preventing real-time data leakages in cloud environments, wherein the computer program product comprises at least one non-transitory computer-readable medium having computer-readable program code portions embodied therein, the computer-readable program code portions which when executed by a processing device are configured to cause the processor to:
identify at least one data source;
collect, by at least one virtual component, data from the at least one data source, wherein the data comprises current user data;
monitor, by the at least one virtual component, the data from the at least one data source;
generate, in an instance after the monitoring of the data, encrypted data by applying an encryption layer to the data, wherein the encryption layer comprises at least one quantum-resistant encryption technique applied to the data;
apply the encrypted data to an anomaly detection layer, wherein the anomaly detection layer comprises an artificial intelligence (AI) engine and a machine learning (ML) model;
determine, by the ML model, an anomaly indicator based on whether an anomaly is present in the data based on the current user data;
determine, by the AI engine, a prediction for the data based on the anomaly indicator and the current user data; and
log, in a distributed ledger, the current user data and the anomaly indicator.

11. The computer program product of claim 10, wherein the computer-readable program code portions which when executed by the processing device are configured to cause the processor to:
determine at least one responsive user account based on the positive anomaly indicator, wherein the responsive user account is associated with historical responses to historical anomalies similar to the positive anomaly indicator; and
trigger, in response to the positive anomaly indicator and the identification of the at least one responsive user account, a transmission of the positive anomaly indicator to at least one response user device associated with the at least one responsive user account.

12. The computer program product of claim 10, wherein the computer-readable program code portions which when executed by the processing device are configured to cause the processor to:
determine at least one cryptographic key for the data; and
apply the at least one cryptographic key the data by a key management component.

13. The computer program product of claim 10, wherein the computer-readable program code portions which when executed by the processing device are configured to cause the processor to:
apply the distributed ledger comprising the data to a cryptographic layer; and
encrypt, by the cryptographic layer, the data with one or more cryptographic algorithms in the cryptographic layer, wherein the one or more cryptographic algorithms comprises at least one of a differential algorithm or secure computation algorithm.

14. The computer program product of claim 10, wherein the computer-readable program code portions which when executed by the processing device are configured to cause the processor to:
Apply the encrypted data from the cryptographic layer to a quantum resistant security layer; and
generate, by the quantum resistant security layer, quantum resistant data from the encrypted data, wherein the quantum resistant security layer comprises at least one of a quantum key distribution or at least one quantum resistant algorithm.

15. The computer program product of claim 10, wherein the computer-readable program code portions which when executed by the processing device are configured to cause the processor to:
allow access, via at least one application programming interface (API) gateway, by at least one response user device to the quantum resistant data.

16. A computer implemented method for securing data by detecting and preventing real-time data leakages in cloud environments, the computer implemented method comprising:
identifying at least one data source;
collecting, by at least one virtual component, data from the at least one data source, wherein the data comprises current user data;
monitoring, by the at least one virtual component, the data from the at least one data source;
generating, in an instance after the monitoring of the data, encrypted data by applying an encryption layer to the data, wherein the encryption layer comprises at least one quantum-resistant encryption technique applied to the data;
applying the encrypted data to an anomaly detection layer, wherein the anomaly detection layer comprises an artificial intelligence (AI) engine and a machine learning (ML) model;
determining, by the ML model, an anomaly indicator based on whether an anomaly is present in the data based on the current user data;
determining, by the AI engine, a prediction for the data based on the anomaly indicator and the current user data; and
logging, in a distributed ledger, the current user data and the anomaly indicator.

17. The computer implemented method of claim 16, further comprising:
determining at least one responsive user account based on the positive anomaly indicator, wherein the responsive user account is associated with historical responses to historical anomalies similar to the positive anomaly indicator; and
triggering, in response to the positive anomaly indicator and the identification of the at least one responsive user account, a transmission of the positive anomaly indicator to at least one response user device associated with the at least one responsive user account.

18. The computer implemented method of claim 17, further comprising:
determining at least one cryptographic key for the data; and
applying the at least one cryptographic key the data by a key management component.

19. The computer implemented method of claim 18, further comprising:
applying the distributed ledger comprising the data to a cryptographic layer; and
encrypting, by the cryptographic layer, the data with one or more cryptographic algorithms in the cryptographic layer, wherein the one or more cryptographic algorithms comprises at least one of a differential algorithm or secure computation algorithm.

20. The computer implemented method of claim 19, further comprising:
applying the encrypted data from the cryptographic layer to a quantum resistant security layer; and
generating, by the quantum resistant security layer, quantum resistant data from the encrypted data, wherein the quantum resistant security layer comprises at least one of a quantum key distribution or at least one quantum resistant algorithm.
